(19) United States
(12) Patent Application Publication
(10) Pub. No.: US 2017/0241459 A1
(43) Pub. Date: Aug. 24, 2017

(54) PROFILE BAR AND PROFILE CONNECTION

(71) Applicant: Hartmut Flaig, Aldingen (DE)

(72) Inventor: Hartmut Flaig, Aldingen (DE)

(21) Appl. No.: 15/512,972

(22) PCT Filed: Jul. 24, 2015
(86) PCT No.: PCT/EP2015/067077

§ 371 Date: Mar. 21, 2017

(30) Foreign Application Priority Data
Sep. 22, 2014 (DE) 20 2014 104 524.4

(51) Int. Cl. F16B 7/18

(52) U.S. Cl. CPC F16B 7/187

(57) ABSTRACT

Profile bar (2) preferably an aluminum alloy, with at least one undercut longitudinal slot (6) which has a slot bottom (8) and extends in the direction of the longitudinal extent (L) of the profile bar (2), and of which the longitudinal slot opening (13) opposite the slot bottom (8) in the direction of a longitudinal slot height (H), perpendicular to the longitudinal extent (L) of the longitudinal slot (6), is bounded by two undercut sections (14, 15) spaced apart by the longitudinal slot opening (13), wherein a longitudinal slot opening width (b), measured perpendicular to the longitudinal extent (L) of the longitudinal slot (6), is less than a maximum longitudinal slot width (bₙ) in a longitudinal slot region located below the undercut sections (14, 15) as seen along the longitudinal slot height (H), wherein a longitudinal duct (9) extending parallel to the longitudinal slot (6) is provided below the slot bottom (8), which duct is spaced from a section (7) forming the slot bottom (8), which is formed as a penetration section and/or forming section made of profile bar solid material, which is penetrable by a connector screw (4) in the direction of the longitudinal slot height (H) for establishing a form-fit with the profile bar (2), and/or into which, for establishing a form-fit with the profile bar (2), a connector screw (4) can be formed in the direction of the longitudinal slot height (H) in such a way that profile bar solid material of the forming section is displaceable into the longitudinal duct (9).

### BACKGROUND OF THE INVENTION

The invention relates to a longitudinal profile bar, in particular to an extruded profile bar made of a lightweight metal alloy, preferably an aluminum alloy, with at least one undercut longitudinal slot which has a slot bottom and extends in the direction of the longitudinal extent of the profile bar, and of which the longitudinal slot opening opposite the slot bottom in the direction of a longitudinal slot height, perpendicular to the longitudinal extent of the longitudinal slot (and perpendicular to the longitudinal slot height), is bounded by two undercut sections spaced apart by the longitudinal slot opening, wherein a longitudinal slot opening width, measured perpendicular to the longitudinal extent of the longitudinal slot, is less than a maximum longitudinal slot width (measured in the same direction) in a longitudinal slot region located below the undercut sections as seen along the longitudinal slot height. Further, the invention relates to a profile connection according to claim 6 with at least one such profile bar.

Profile connections comprising a first and a second, respectively longitudinal profile bar made of a lightweight metal alloy, generally an aluminum alloy, are sufficiently known from the prior art. Here, threaded sleeves with male threads are generally used, which are fixed in an undercut longitudinal slot of one of the profile bars and generally serve as an abutment for a screw head of a connector screw, wherein the connector screw penetrates a through-opening of the threaded sleeve and is screwed with a screw thread (male thread) to an end support part (sliding block), wherein the sliding block is generally located in the undercut longitudinal slot of the profile bar running orthogonally to the longitudinal extent of the connector screw.

At this point, reference is made merely exemplary to EP 1 574 725 B1, EP 0 458 069 B1 and DE 20 2004 017 815 U1. All patent documents show different embodiments of profile connections.

The factor to be improved in all profile connections is the robustness or stability thereof, in particular upon application of force perpendicular to the longitudinal extent of the connector screw to be used.

### SUMMARY OF THE INVENTION

Based upon the prior art, the object of the invention is to provide a profile bar which is configured such that a profile connection created with this bar has an increased robustness or stability, in particular upon application of force perpendicular to the longitudinal extent of the connector screw to be used. Further, the object is to provide an improved profile connection.

This object is achieved regarding the profile bar as well as regarding the profile connection with the features disclosed herein.

Advantageous configurations of the invention are also indicated herein. All combinations of at least two features disclosed in the description, the claims and/or the figures are within the scope of the invention. To avoid repetitions, features disclosed according to the device, in particular with regard to a possible later patent application, are to be considered as disclosed according to the method and be claimable. Also, features disclosed according to the method are to be considered as disclosed according to the device and are to be claimable.

The idea underlying the invention is to provide the longitudinal profile bar, which is preferably configured as an extruded profile bar made of a lightweight metal alloy, in particular of an aluminum alloy, with a longitudinal duct extending parallel to the longitudinal slot in a region below the slot bottom relative to the longitudinal slot height (measured from the longitudinal slot opening to the slot bottom), wherein a closed profile section configuring the slot bottom of the undercut longitudinal slot, i.e. configured from a profile bar solid material, is configured as penetration section, therefore only has such a small material thickness that it is penetrable by means of a connector screw (not being part of the profile bar), which intersperses the longitudinal slot opening of the undercut longitudinal slot for establishing a form-fit with the profile bar in the direction of the longitudinal slot height (oriented perpendicular to the slot width and perpendicular to the longitudinal extent of the longitudinal slot), in particular by screwing the connector screw in the direction of the slot bottom or through the slot bottom respectively. In other words, in a profile bar configured according to the concept of the invention, a longitudinal duct is located in a region below the longitudinal slot, i.e. farther spaced apart from the side surface of the profile bar comprising the longitudinal slot than the slot bottom, which duct enables penetration or punching, respectively, of the penetration section spaced apart the longitudinal duct from the longitudinal slot by means of a connector screw, in particular if said screw is screwed to a sliding block located in the undercut longitudinal slot (abutment part) for creating a profile connection, wherein the connector screw is screwed upon screwing in the direction of the slot bottom of the longitudinal slot and through the bottom into the penetration section material (profile bar solid material), wherein it is particularly preferable if the penetration section has a material thickness, which enables punching at least in sections of the penetration section then preferably configured as punching diaphragm by the above-mentioned twisting of the connector screw, that is a quarrying of penetration section material into the longitudinal slot for creating an opening in the penetration section, which encloses the connector screw so that a form-fit between the connector screw and the penetration section results, with the effect that stresses or forces, respectively, oriented perpendicular to the longitudinal extent of the connector screw can be received in an improved manner. Preferably the material thickness of the penetration section is selected such that a connector screw is sufficient by introducing a manual torque, i.e. not with an automated tool, to be able to introduce, in particular punch, i.e. quarry a penetration opening reaching up into the longitudinal slot in the penetration section. A profile connection created with a profile bar configured according to the concept of the invention is characterized by an increased stability and robustness.

Here, penetrating the penetration section means that an opening extending up into the longitudinal slot by means of the connector screw in the penetration section can be created by means of the connector screw, wherein the connector screw protrudes into the so-created opening in a completed profile connection, and intersperses it particularly preferably up into the longitudinal slot. Preferably, profile bar solid material is first deformed into the longitudinal duct in the direction of the longitudinal slot height by the connector screw, wherein upon further twisting (screwing) of the connector screw, in particular the sliding block to be received in the longitudinal slot, a slug or profile solid material, respectively, tears off or breaks off (is punched), respectively, from the remaining profile solid material of the penetration section in a region below the connector screw.

In an alternative embodiment according to the invention of the profile bar, the section configured as solid material does not necessarily be penetrated by the connector screw or be penetrable—it is rather sufficient if the slot bottom is formed of profile solid material by a forming section or if the longitudinal duct is spaced apart from the longitudinal slot via a forming section formed from profile solid material, into which a connector screw can be formed in in the direction of the longitudinal slot height (H) in such a way that the profile solid material of the forming section can be displaced into the longitudinal duct (can be dented). In contrast to the above described embodiment, the connector screw is not completely penetrated by the profile solid material section between the longitudinal slot and the longitudinal duct, but is merely formed into it. In this way, a form-fit can be established, wherein in contrast to the first alternative no continuous opening is formed in the above-mentioned section by the connector screw, but (merely) a closed depression or impression, respectively in the direction of the longitudinal slot height.

Independently from the configuration with penetration and/or forming section, the invention also provides the advantage that a profile connection created with such a profile bar can easily be detached by unwinding the at least one connector screw, wherein a once detached profile connection can easily be created again by replacing the connector screw into the original depression or through-opening in the section between the longitudinal slot and the longitudinal duct. As will be described later, a facilitated finding of the depression or through-opening is possible by the realization of a connector screw tapering on the front side—to that end, a cone section can be realized, for example, in the front section of the connector screw.

Particularly preferably, the connector screw is made of a metal, which is harder than the metal material of the profile bar. More particularly preferably, it is a steel screw, which further preferably is manufactured by cold forging. Possibly, the connector screw can be hardened by a tempering step.

With regard to a cost-efficient manufacturability of the connector screw to be used in the scope of the profile connection, it is preferred if the screw is configured of solid material in a front region, that is comprises no depression on the front face (front side). Here, a front section may comprise a cylindrical contour or a cone section with regard to an improved or facilitated, respectively, finding of a depression or through-opening already created, wherein an improved centering is ensured as well as possibly improved adhesive forces for improving the created profile connection. Other alternative embodiments to be described later of the connector screw with depression and cup point at the front side are also conceivable.

More particularly preferably is an embodiment of the profile bar, in which the bar not only comprises a single combination of undercut longitudinal slot and longitudinal duct arranged neighboring, which is spaced apart from the longitudinal slot via a penetration section configured as already described, but if the profile bar comprises such a combination on at least two sides, more particularly preferably on all four sides, wherein respective two sides, in particular side surfaces of the profile bar are arranged rectangular to one another. Particularly preferably is an embodiment of the profile bar with a rectangular contour, wherein the edges of the rectangle preferably are not configured pointed but rounded. Particularly preferably is a rectangular cross-sectional contour, in particular with rounded edges.

In development of the invention it is provided that the penetration section has a material thickness measured in the direction of the longitudinal slot height of less than 5 mm to create as easily or with limited effort, respectively, a through-opening in the penetration section by twisting the connector screw. It has proven particularly advantageous if said material thickness is selected from a value range of between 0.5 mm and 3 mm. A material thickness between 1 mm and 2 mm, further preferably between 1.3 mm and 1.8 mm seems to be the optimum.

Particularly convenient is an embodiment of the profile bar, in which the profile bar comprises a central duct, i.e. a duct arranged centric relative to the front face of the profile bar and extending in the direction of the longitudinal slot height of the profile bar, which duct comprises for example according to a preferred embodiment a circular cross-sectional contour, wherein a serrated embodiment, i.e. an embodiment with indentations or depressions, respectively, extending next to one another in the circumferential direction and in radial direction, is possible, as well as an embodiment with an annular or not serrated, respectively, hollow-cylinder shell contour.

There are different options with regard to the specific configuration of the longitudinal duct. Preferably, a height extent of the longitudinal duct selected in the direction of the longitudinal slot height is greater than the height extent “material thickness” of the penetration section in this direction, to enable a movement away from or a removal, respectively, of a, preferably punched or unhinged, solid material section of the penetration section, which results upon creation of a through-opening in the penetration section by means of the connector screw. It can also be advantageous in the case of the realization of a forming section to configure the height extent of the longitudinal duct greater than the height extent “material thickness” of the forming section, to thus facilitate a facilitated forming in the forming section or indenting, respectively, of the forming section onto the longitudinal duct.

It is more particularly preferably, if the longitudinal duct comprises a rectangular cross-sectional contour (with view of the front face) and/or that the cross-sectional contour of the longitudinal duct has a smaller extent in the direction of the longitudinal slot height than perpendicularly. Preferably, the width of the longitudinal duct is greater than its height extent, wherein the longitudinal duct width corresponds preferably at least to the width of the longitudinal slot opening.

The invention also leads to a profile connection with at least one profile bar configured according to the concept of the invention (first profile bar). According to a first alternative, the profile connection is characterized in that an opening is provided in the penetration section which encloses a connector screw, wherein preferably the connector screw protrudes up into the neighboring longitudinal duct. The above-mentioned opening or through-opening, respectively, is preferably created by means of the connector screw, wherein further preferably the opening is created at least partly by punching, i.e. breaking off of a solid material section through penetration section, in particular by the connector screw being driven in the direction in the penetration section by screwing together with a sliding block. In the region of its rear end, the connector screw comprises preferably a drive, for example a polygonal drive, in particular an Allen drive, or a torx drive.

According to a second alternative, the connector screw is only formed into the section then serving as forming section between the longitudinal slot and the longitudinal duct in such a way that material is dented into the longitudinal duct. In other words, an indentation or connection, respectively, is created in this case by the connector screw, which serves as a form-fit connection.

In general, it is basically also possible for the case of the configuration of the section between the longitudinal slot and the longitudinal duct as penetration duct, to not penetrate the duct by means of the connector screw, but only form the connector screw into the penetration section in such a way that a slug is not punched, but merely a depression in the slot bottom of the longitudinal slot results, wherein penetration section material is dented or formed, respectively, into the longitudinal duct. So it is not mandatory to penetrate the penetration section by means of the connector screw or to break off or punch, respectively, material for creating a through-opening—it can be sufficient for a simplified form-fit connection to deform the penetration section merely by means of the connector screw or create a depression by means of the connector screw, respectively, in such a way that material of the penetration section is formed into or dented in the neighboring longitudinal duct.

More particularly preferably is an embodiment, in which the connector screw is screwed with its male thread to a sliding block arranged in the longitudinal slot, which is interspersed by the connector screw in the direction of the longitudinal slot height of the longitudinal slot. Preferably, this sliding block serves for the fixation of a connection of the first profile bar with a further component, in particular a second profile bar comprising an undercut longitudinal slot, which is configured further preferably according to the concept of the invention. Instead of a second profile bar, another component, for example a fastening bracket or a hinge joint in the described manner can be secured to a first profile bar. For fixation of the further component, a fixing sleeve to be interspersed by the connector screw needs not necessarily be provided—the fixing component per se or another component can, in particular for the case of the realization of the component to be secured to the first profile bar not as second profile bar, be formed by the component to be fixed. In other words, a screw head of the connector screw can directly or indirectly be supported by the component to be fixed—a fixing sleeve, as this is advantageous for fixing a second profile bar, needs not be provided. More particularly preferably, the profile connection comprises multiple such connector screws, which, if required, can be screwed in the longitudinal slot of the first profile bar each with their own sliding block, or with a common sliding block.

In development of the invention it is provided advantageously that a component oriented preferably perpendicular to the longitudinal extent of the first profile bar with regard to its longitudinal extent, in particular a second profile bar is connected to the first profile bar, wherein the connector screw advantageously intersperses a fixing sleeve arranged in an undercut longitudinal slot of the second profile bar, wherein it is further preferred if the connector screw rests with a screw head on a front face of the sleeve facing away from the first profile bar. If required, the component can be connected to the first profile bar via multiple parallel connector screws screwed to a common or to separate sliding blocks, wherein preferably lateral connectors are connected to the penetration section in a form-fit manner and intersperse the section preferably up to the longitudinal duct. As mentioned, the connector screw can also be formed in the penetration section or alternatively in a forming section in such a way that in any case a depression is created in the solid material section between the longitudinal slot and the longitudinal duct and the solid material is deformed into the longitudinal duct.

It has proven particularly advantageous if the connector screw comprises a cone section, in particular in the region of a front end, i.e. end-side end for establishing a form-fit connection to the penetration section of the first profile bar, wherein in the scope of the profile connection the connector screw with the cone section is supported on the circumferential edge of an opening, preferably created with the connector screw in the penetration section. It has proven particularly advantageous with regard to the realization of a particularly stable connection if the cone section is configured as morse taper, in particular with a cone angle (angle between the skin surface of the cone and the longitudinal axis of the screw of 1.26′). Altogether it is advantageous if the above-mentioned cone angle is not more than 10°, more particularly preferably a value range of between 0.5° and 10° is selected, more particularly preferably between 1° and 5°, even further preferably between 1° and 3°. Here, the cone section tapers in the direction of the front end, i.e. the end of the connector screw located in the direction of screwing. Thereby, an additional blocking against unwinding of the connector screw can be obtained. Alternatively, it is also conceivable to provide simply a cylinder section instead of a cone section—though a cone section is advantageous in general with regard to the finding of a depression or opening already created before—for economic reasons however, a cylinder section can also be realized.

It is particularly advantageous if the connector screw comprises a flat front face on the front end thereof located in the direction of winding-in, i.e. does not taper, whereby a desired (not required) punching effect can be obtained in a particularly simple manner. Alternatively, the connector screw comprises a preferably cylindric opening in the region of the front end thereof, which is circumferentially limited by, in particular annular, forming means for facilitated forming in or penetration of the penetration section. More particularly preferably, the forming means are configured in such a way that they form into the penetration section to a certain depth upon screwing of the connector screw, wherein it is possibly according to a first alternative that the forming means form up to reaching the longitudinal duct upon further screwing of the connector screw and a solid material of the penetration section broken off is received in the opening. Alternatively, it can be realized that a lower, i.e. further spaced apart from the longitudinal slot bottom, section of the penetration section is or will be punched for creating the desired opening. Here it is particularly preferred, but not required, that the front-faced opening in the connector screw has a smaller depth extent than the material thickness of the penetration section measured in the direction of the longitudinal slot height.

With regard to the dimensioning of the connector screw, it is advantageous for the case of the realization of the section between the longitudinal slot and the longitudinal duct as penetration duct, if the length of a screw shaft of the connector screw, measured from the bottom edge of a screw head to the front end is the same or smaller than the distance, measured in the direction of the height extent of the longitudinal slot, between the duct bottom and a counter bearing for the screw head, which is preferably formed by a (upper) circumferential edge of a fixing sleeve facing away from the first profile bar, which is preferably received in a second profile bar.

With regard to the specific configuration of the forming means, there are different options. Preferably, the forming means are configured as cup point, either with a cutting edge running linearly or with a structured, in particular waved or toothed cutting edge.

For the case of the realization of forming means, it is preferred if the wall section circumferentially closed is configured without male thread.

To enable forming in of the forming means in the section between longitudinal slot and longitudinal duct as comfortable and effortless as possible, it is provided according to the development that the forming section with the biggest part of the axial extent thereof comprises, in particular (also) in the region of the preferably provided wall section circumferentially closed a smaller diameter than the male thread of the shaft, wherein preferably the outer diameter of the forming section corresponds the core diameter of the male thread.

Additionally, facilitating the forming can be achieved in that a radial cross section of the forming profile tapers, in particular in the form of a cutter in axial direction to the front to thus increase the surface pressure in the region of the forming edge. The front region of the forming means can be hardened, as required.

In general it is possible that the connector screw comprises a pin or grub shape, i.e. has no screw head. In this case, the connector screw, in particular within the scope of a profile connection preferably together with a combination of a sliding block received in an undercut longitudinal slot of a first profile bar and a sleeve anchored in the profile arranged orthogonal thereto, which sleeve then preferably is configured as female thread.

Independent of the specific configuration of the front connector screw end, it is preferred if it is configured without male thread, wherein generally also a configuration with male thread seems realizable.

More particularly preferably is an embodiment in which the connector screw comprises a screw head with which the screw can be supported by a counter bearing within the scope of the profile connection. This counter bearing can be formed by a fixing sleeve to be secured in a second profile bar, in particular to be secured in an undercut longitudinal slot of a second profile bar.

It is more particularly preferred that the axial extent of the front-faced opening is at least 3 mm and in particular is selected from a value range of between 3 mm and 5 mm. More particularly preferably, the axial extent is at least 5% of the overall axial extent of the connector screw.

The counter bearing can be formed directly or indirectly by the component to be fastened, for example an angle or a hinge, in particular for the case that component differing from a second profile bar are to be fastened to the first profile bar.

The invention also leads to a claimable method, in particular within the scope of a possible later patent application, for creating a profile connection configured according to the concept of the invention, wherein the method is characterized by the following steps: Providing a profile bar according to the concept of the invention and a connector screw, preferably configured as mentioned above; twisting of the connector screw and thereby (due to the thread incline of the connector screw male thread) advancing the connector screw into the penetration section, wherein the screwing of the connector screw is effected preferably in a sliding block received in the undercut longitudinal slot of the profile bar, wherein in twisting and advancing the screw, an opening for the screw into the penetration section is created, in particular punched, wherein the opening is configured preferably as through-opening to the neighboring longitudinal duct.

According to a variant of the method, the connector screw does not penetrate the section (forming section) between the longitudinal slot and the longitudinal duct, but merely deforms section solid material into the longitudinal duct or forms a depression in the section, respectively. In contrast to the first variant, the slug material is not removed or punched, respectively, but keeps connected to the neighboring profile bar solid material of the (formed) section.

Additionally or as an alternative to the second profile bar, it is possible to connect a component differing therefrom to the first profile bar, for example a hinge or an angle. This component can be fixed with the connector screw to the first profile bar in the manner described above, wherein according to a first alternative the connector screw penetrates the section then configured as penetration section between the longitudinal slot and the longitudinal duct and according to an alternative embodiment then simply forms as section configured as forming section or serving as forming section, respectively, and deforms or indents, respectively, material of the forming section into the longitudinal duct.

It is particularly preferably if a second profile bar configured in particular according to the concept of the invention is connected to the first profile bar, wherein in this case the connector screw preferably intersperses a sleeve arranged or fixed, respectively, in the second profile bar, more specific an undercut longitudinal slot of the second profile bar and is screwed to a sliding block to be received in the first longitudinal slot of the first profile bar in the above-described manner and thereby a through-opening in the penetration section to the longitudinal duct is created, wherein it is particularly advantageous if in the completed connector screw the connector screw with the outer circumference, in particular the outer circumference of an optional cone section is supported on the side of the edge in the opening of the penetration section.

### BRIEF DESCRIPTION OF THE DRAWINGS

Further advantages, features and details of the invention result from the exemplary embodiments preferred of the following description and from the drawings.

The drawings show in:

FIG. 1 and FIG. 2 two different views twisted by 90° relative to one another of a profile connection comprising at least one profile bar configured according to the concept of the invention,

FIG. 3 and FIG. 4 detailed views of FIG. 1 or 2, respectively,

FIG. 5 punching waste resulting from the creation of through-openings in the penetration section,

FIG. 6 an optional configuration of a connector screw, and

FIG. 7 a highly schematic illustration of a profile bar in a longitudinal sectional view (only upper half), wherein the section between the longitudinal slot and the longitudinal duct is configured as forming section or is only used as forming section—here, no solid material of the section 7 is punched by the connector screw, but merely deformed into the longitudinal duct 9.

### DETAILED DESCRIPTION

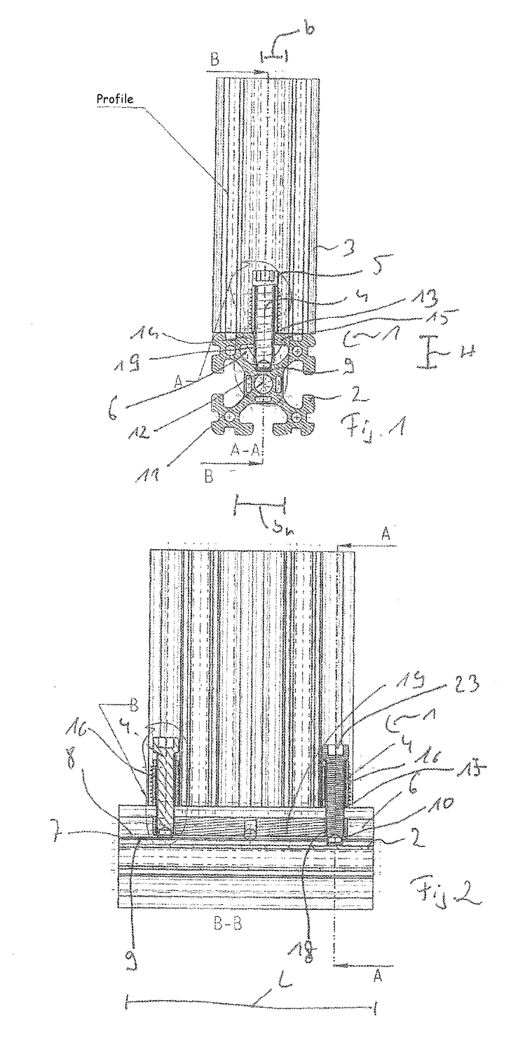

FIGS. 1 and 2 show a profile connection 1 comprising a longitudinal (first) profile bar 2 which is configured as extruded profile bar made of an aluminum alloy. Further, the profile connection 1 comprises a component 3 which also is configured as profile bar 2 (second profile bar) oriented perpendicular to the first profile bar 2.

The profile bar 2 and the component 3 are fixed to one another by means of a connector screw 4 exemplified comprising a screw head 5 here.

The screw intersperses a section 7 to be described later in detail in the direction of the longitudinal height H of an undercut longitudinal slot 6, which section forms a slot bottom 8 of the undercut longitudinal slot 6 as well as a longitudinal duct 9 provided below the undercut longitudinal slot 6 spaced apart from the undercut longitudinal slot 6. The section 7 can be configured as penetration section according to a first alternative, which is penetrable or punchable, respectively, by a connector screw to create a through-opening between the longitudinal slot and the longitudinal duct. Upon comparatively slight tightening of the connector screw, it is possible to not penetrate or punch, respectively, the penetration section, but merely form it in such a way that a depression is created and material of the section is (in)dented or formed, respectively, into the longitudinal duct. It is also conceivable, according to an alternative embodiment, not to design the section 7 as penetration section from the first, but only as forming section which enables the forming of a connector screw in the direction of the longitudinal height of the longitudinal slot in such a way that an indentation or depression, respectively, results in the forming section and material of the forming section is indented or formed, respectively, into the longitudinal duct.

It can be seen from FIG. 2 on the right that a connector screw 4 (the profile connection 1 contains exemplified two such connector screws 4) intersperses an opening 10 introduced by means of the connector screw 4 into the penetration section 7 and protrudes into the longitudinal duct 9. The circumferential edge of the opening 10 supports the connector screw 4 laterally so that forces oriented perpendicular to the longitudinal extent of the component 3 can optimally be received.

Further, it can be seen from FIG. 1 that the (first) profile bar 2 seen in the cross-sectional view comprises four identical side surfaces, wherein the cross-sectional contour is a rectangle. An identically configured combination of undercut longitudinal slot 6 and longitudinal duct 9 spaced apart by a section 7 here exemplified as penetration section is assigned to each side surface.

Furthermore, it can be seen from FIG. 1 that the profile bar 2 comprises a central duct 11, whereof the longitudinal duct 9 is spaced apart by a solid material section 12 in the direction of the height extent H of the undercut longitudinal slot 6.

A longitudinal slot opening 13 of the undercut longitudinal slot is limited by two undercuts 14, 15 opposite to one another which define the width b of the longitudinal slot opening 13. A maximum longitudinal slot width bₙ is achieved in a region below the undercuts 14, 15. The maximum longitudinal slot width bₙ and the longitudinal slot height extent H oriented perpendicular thereto are oriented perpendicular to the longitudinal extent L (see FIG. 2 of the extruded profile bar 2).

It can be seen from FIG. 2 that each connector screw intersperses a sleeve 16 and is supported with the screw head 5 on the side facing away from the first profile bar 2. The sleeve 16 is received in an undercut longitudinal slot 6 of the component by means of a male thread or other for example bayonet-like fixing means, for example. The connector screw 4 respectively intersperses the sleeve 16 oriented perpendicular to the longitudinal extent L of the profile bar 2 and is screwed to the female thread 18 of a sliding block 19 (counter bearing part) with the male thread 17 thereof, which block is received in the undercut longitudinal slot 6. The sliding block 19 in the mounted state (see FIG. 2 on the right) is interspersed by the connector screw 4, which additionally protrudes into the section 7 and intersperses the section preferably also into the longitudinal duct 9.

An optional embodiment of the connector screw 4 is shown in FIG. 6. The screw comprises exemplified a screw head 5.

It is shown merely exemplified that an opening 20, here a blind opening is provided in a front end, which is surrounded by forming means 21, here in the form of a continuous cup point which is arranged a circumferentially closed circumferential wall 22 on the end side. In an alternative embodiment, which can be manufactured in a simplified manner, also a flat front end, i.e. an end without opening 20 or with an opening 2 with smaller axial extent can be provided.

In FIG. 6, a drive 23 opposite the front end or facing away therefrom is not shown. The drive can be seen in FIG. 2 for example.

FIG. 3 shows a detail of a completed connection or the detail of FIG. 1, respectively, which corresponds to the right connector screw connection according to FIG. 2.

The sleeve 16 in the longitudinal slot 6 in the component 3 (second profile bar) can be seen. This sleeve 16 is configured without female thread. The screw head 5 of the connector screw 4 is supported on the sleeve 16 on the front face, wherein the connector screw 4 is screwed to a sliding block 19 in the undercut longitudinal slot 6 with the male thread thereof. To that end, the connector screw 4 intersperses the longitudinal slot opening 13. Further, the connector screw 4 intersperses the sliding block 19 in the direction of the height extent H of the undercut longitudinal slot 6 and intersperses an opening 20 created by means of the connector screw 4 in the section 7 to the longitudinal duct 9. Preferably, the section 7 is configured as punching diaphragm which can be punched. The section has a material thickness M of about 1.5 mm in the exemplary embodiment shown.

The reject 24 (slug) resulting from the introduction of the opening 20 can be referred to as punching waste, as the opening 20 is created in a lower region of the opening by punching the reject 24. The reject 24 is located within the longitudinal duct 9, into which the connector screw 4 protrudes. It can be seen that the distance between the central duct 11 and the longitudinal duct 9 is greater than the material thickness M of the penetration section 7. However, this is not required. The width extent of the longitudinal duct 9 comprising a rectangular cross-sectional contour corresponds approximately to the width b of the longitudinal slot opening 13. In an embodiment with section 7 configured as forming section or with connector screw slightly tightened upon realization of a penetration section instead of a forming section, no reject (slug) results—rather, in this case, as shown in FIG. 7, only section material (solid material) of the section 7 is deformed or indented, respectively, into the longitudinal duct 9.

Here, FIG. 7 shows an upper half of a first profile bar in a longitudinal sectional view, wherein a connector screw 4 is shown highly schematic, which, in analogy to FIG. 3 in a further component, can be fixed to in particular a second profile bar. The connector screw intersperses a sliding block 9 in the undercut longitudinal slot 6. The connector screw 4 indents the section 7 namely in the direction of the height extent H of the longitudinal slot 6 into the longitudinal duct 9.

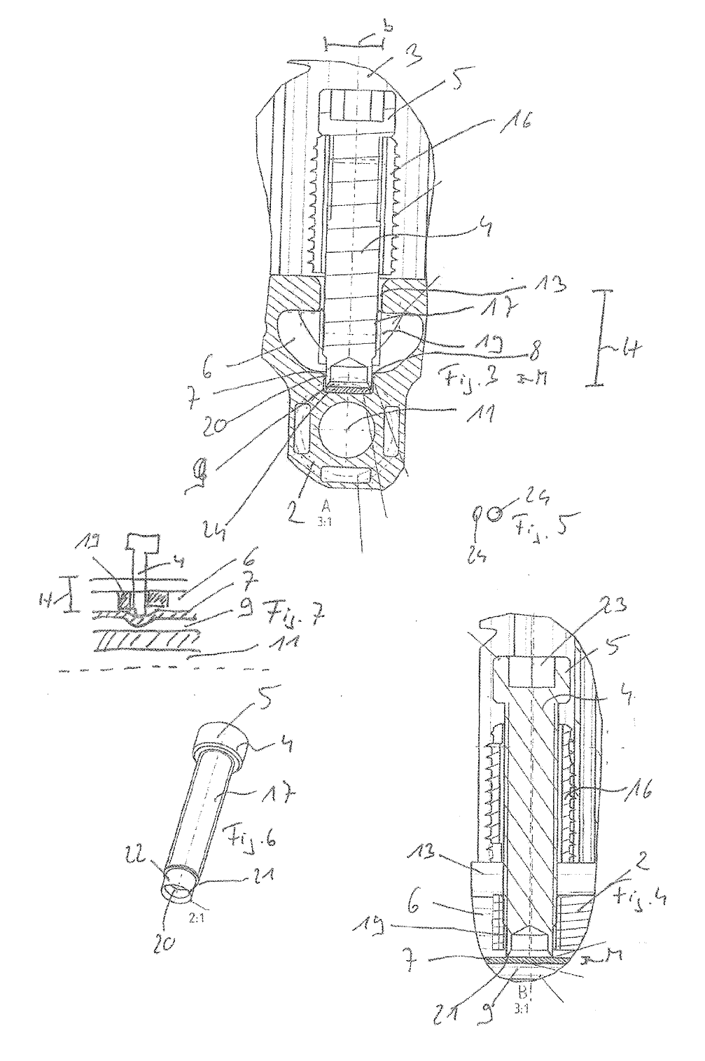

FIG. 4 shows the situation on the left in FIG. 2 in an enlarged detail. In FIG. 4, the connector screw 4 is not finally mounted, but still rests on the section 7 configured as penetration section, which is configured as punchable punching diaphragm. The connector screw 4 already intersperses a sleeve 16 received in an undercut longitudinal slot 6 of the component 3 in the direction of the height extent H of the undercut longitudinal slot 6 of the first profile bar 2 and is screwed to the sliding block 19 inside the undercut longitudinal duct 6 and intersperses this region so that a front end of the connector screw 4, which is provided (exemplified) with forming means 21, abuts the penetration section 7. By twisting the connector screw 4 in the circumferential direction, the screw is advanced into the solid material of the penetration section 7 in the direction of the longitudinal slot height extent H and in such a way that the reject illustrated in FIG. 5 results, which then falls into the neighboring longitudinal duct.

1. Profile bar (2) preferably an aluminum alloy, with at least one undercut longitudinal slot (6) which has a slot bottom (8) and extends in the direction of the longitudinal extent (L) of the profile bar (2), and of which the longitudinal slot opening (13) opposite the slot bottom (8) in the direction of a longitudinal slot height (H), perpendicular to the longitudinal extent (L) of the longitudinal slot (6), is bounded by two undercut sections (14, 15) spaced apart by the longitudinal slot opening (13), wherein a longitudinal slot opening width (b), measured perpendicular to the longitudinal extent (L) of the longitudinal slot (6), is less than a maximum longitudinal slot width (bₙ) in a longitudinal slot region located below the undercut sections (14, 15) as seen along the longitudinal slot height (H),
wherein
a longitudinal duct (9) extending parallel to the longitudinal slot (6) is provided below the slot bottom (8), which duct is spaced from a section (7) forming the slot bottom (8), which is formed as a penetration section and/or forming section made of profile bar solid material,
which is penetrable by a connector screw (4) in the direction of the longitudinal slot height (H) for establishing a form-fit with the profile bar (2),
and/or
into which, for establishing a form-fit with the profile bar (2), a connector screw (4) can be formed in the direction of the longitudinal slot height (H) in such a way that profile bar solid material of the forming section is displaceable into the longitudinal duct (9).

2. Profile bar according to claim 1, wherein the section (7) has a material thickness measured in the direction of the longitudinal slot height (H) of less than 5 mm.

3. Profile bar according to claim 1, wherein the longitudinal slot (6) is spaced in the direction of the longitudinal slot height (H) from a central duct (11) of the profile bar (2) extending in the direction of the longitudinal extent (L) of the profile bar (2), wherein the material thickness (M) of the section (7) measured in the direction of the longitudinal slot height (H) is smaller than the distance between the longitudinal duct (9) and the central duct (11), measured in the direction of the longitudinal slot height (H).

4. Profile bar according to claim 1, wherein the longitudinal duct (9) has a rectangular cross-sectional contour and/or wherein the cross-sectional contour of the longitudinal duct (9) has a smaller extent in the direction of the longitudinal slot height (H) than perpendicularly.

5. Profile bar according to claim 1, wherein the profile bar (2) comprises four side surfaces, wherein respective two neighboring ones of the side surfaces are arranged rectangularly to one another and wherein on at least two side surfaces an undercut longitudinal slot (6) is provided with assigned longitudinal duct (9) as well as section (7) arranged between longitudinal slot (6) and longitudinal duct (9).

6. Profile connection with a first profile bar according to claim 1, wherein the section (7) is penetrated in the direction of the longitudinal slot height (H) of the assigned undercut longitudinal slot (6) by a connector screw (4) or in wherein the section (7) a connector screw (4) is formed in the direction of the longitudinal slot height (H) of the assigned undercut longitudinal slot (6) in such a way that profile bar solid material is deformed into the longitudinal duct (9).

7. Profile connection according to claim 6, wherein the connector screw (4) with its male thread (17) is screwed to a sliding block (19) arranged in the longitudinal slot (6), which is interspersed by the connector screw (4) in the direction of the longitudinal slot height (H) of the longitudinal slot (6).

8. Profile connection according to claim 6, wherein a component (3) is secured to the first profile bar (2) by means of the connector screw (4).

9. Profile connection according to claim 8, wherein the connector screw (4) is arranged to penetrate a sleeve (16) fixed in the longitudinal slot (6) of the second profile bar (2).

10. Profile connection according to claim 6, wherein the connector screw (4) comprises a cone section for laterally supporting on a circumferential edge of a created opening (20) or depression in the section (7) by means of the connector screw (4) by punching.

11. Profile connection according to claim 6, wherein the connector screw (4) comprises at its front end a flat front face for forming and/or penetrating the section (7), or wherein the connector screw (4) comprises in the region of its front end a front-faced, cylindrical opening (20), which is circumferentially limited by annular forming means (21) for facilitated forming in and/or penetration of the section (7).

12. Profile connection according to claim 11, wherein the forming means (21) are formed as cup point.

13. Profile bar according to claim 2, wherein the material thickness is between 0.3 mm and 4 mm.

14. Profile bar according to claim 3, wherein the longitudinal slot (6) is spaced by a solid material section (12) in the direction of the longitudinal slot height (H) from the central duct (11) of the profile bar (2) extending in the direction of the longitudinal extend (L) of the profile bar (2).

15. Profile bar according to claim 5, wherein all the four sides surfaces have the undercut longitudinal slot (6) provided with the assigned longitudinal duct (9) as well as the section (7) arranged between the longitudinal slot (6) and the longitudinal duct (9).

16. Profile connection according to claim 6, wherein the connector screw (4) comprises a male thread (17).

17. Profile connection according to claim 8, wherein the component (3) comprises a second profile bar comprising an undercut longitudinal slot (6) at a right angle to the first profile bar (2).

18. Profile connection according to claim 10, wherein the cone section is at the end of the connector screw (4), and is formed as a morse taper with a cone angle between the longitudinal central axis of the screw and cone skin surface of between 0.5° and 10°.

19. Profile connection according to claim 12, wherein the cup point is in a radial plane relative to the longitudinal extent of the connector screw (4).

20. Profile connection according to claim 12, wherein the cup point comprises a wave profile or saw-tooth profile.
